(19) United States
(12) Patent Application Publication
(10) Pub. No.: US 2018/0039987 A1
(43) Pub. Date: Feb. 8, 2018

(54) MULTI-FUNCTION TRANSACTION CARD

(71) Applicant: David Molino, Thomastown (AU)

(72) Inventor: David Molino, Thomastown (AU)

(21) Appl. No.: 15/553,829

(22) PCT Filed: Feb. 27, 2015
(86) PCT No.: PCT/AU2015/000119

§ 371 Date: Aug. 25, 2017

(51) Int. Cl. G06Q 20/40; G06Q 20/34

(52) U.S. Cl. CPC G06Q 20/4012; G06Q 20/341

(57) ABSTRACT

A system to provide a multi-function transaction card is disclosed. In one example, the system includes a card and a functionality transfer unit. The card incorporates a magnetic stripe for transmitting data to and recording data from the functionality transfer unit and for the making of magnetic stripe-based transactions, and contact and contactless provisions for transmitting data to and receiving data from said functionality transfer unit, for the making of contact or contactless transactions and for the card to receive electrical current. The functionality transfer unit is operated to read data from a conventional transaction card, to analyze the data to extract that required to permit said multi-function card to operate as a clone of the conventional transaction card. Commands are inputted via a selection of commands in a display of the functionality transfer unit and executed via pressing of an “Execute” button.

### CROSS-REFERENCE TO RELATED APPLICATIONS

This Utility Patent Application is a U.S. National Stage filing under 35 U.S.C. §371 of PCT/AU2015/000119, filed Feb. 27, 2015, incorporated by reference herein.

### BACKGROUND

This invention relates generally to cards employed to authorize transactions of various types. More specifically, it relates to polymer cards which are employed to authorize transactions by their being read or interrogated by electronic means, the process ranging from simple contact or non-contact reading to a complex process of interrogation and response.

The plastic card is now almost ubiquitous in modern society, being employed to authorize a wide range of transactions. Cards for a variety of purposes are normally made from plastic, with basic dimensions of 54 mm×85.5 mm. The material is normally polyvinyl chloride, but sometimes polyethylene terephthalate-based polymers, acrylonitrile-butadiene-styrene or polycarbonate. Cards have also been made from treated paper.

Typical of such transactions conducted through the use of such cards are: borrowing of a book from a library, gaining access to secure premises, applying for a membership discount at a department store, verifying membership of an organization, making a financial transaction, entering a reserved parking area, accessing government health services, and utilizing public transport. It is now common for persons to carry multiple cards for each particular function, totaling upwards of a dozen or more cards, to the point that the convenience of the card has been negated. While some work has been done in development of multi-functional cards, which have the potential to reduce the number of cards required to be carried, this has apparently been limited by the differing functionalities involved.

The earliest card transactions were made with paper vouchers interleaved with carbon paper. Cards were embossed with an identifying number, the owner's name and validity data. To make a purchase transaction, a voucher was superimposed upon a card in an embossing unit incorporating a plate embossed with details of the merchant. A roller of a hard, elastomeric material was then run back and forth over the voucher, resulting in the transfer of an image of the card and plate embossings to the voucher. The sales person then inserted by hand the date and value of the transaction. One page of the voucher was retained by the merchant, one was sent to the sponsoring bank for payment and one was given to the purchaser. The card carried a specimen signature of the card owner, whose possession of the card and signing of the voucher were the only authentication factors. Obviously, security of this system was low, with cards being readily cloned and only perfunctory checking of signatures by shop assistants.

To create a higher level of security, the magnetic stripe card was introduced. This card incorporated the embossed data of the paper-transaction card, together with a stripe of polymer recording tape coated with iron oxide. Data was recorded on the stripe in Universal Product Code (UPC) and included details of the owner, validity data, details of the sponsoring bank and a secret personal identification number (PIN). The card also carried a specimen signature of the card owner. The merchant inserted the amount of the transaction into the point of sale unit and all transaction details were transmitted to the sponsoring bank. The signed sales chit was retained by the merchant as proof of the transaction and a copy was given to the purchaser. Possession of the card, insertion of the PIN and signing of a chit generated by the point of sale unit provided a higher level of security. However, security of this system was still relatively low, with cards being readily cloned by surreptitious reading of data from the magnetic stripe and, as shop assistants began to rely upon the PIN for security, signature checking became even more perfunctory. Most such cards incorporated a holographic logo which, being difficult to replicate, allowed cloned cards to be readily detected.

Some 20 years following the introduction in the 1950s of the first credit cards, an alternative payments vehicle in the form of debit cards appeared. These give access to funds in a user's bank account and can function in online and offline form. Online debit cards require electronic authorization of every transaction and the debits are reflected in the user's bank account immediately. A transaction may be additionally secured by means of a personal identification number (PIN) authentication system. Some online cards requiring such authentication for every transaction have essentially becoming enhanced automatic teller machine (ATM) cards. A difficulty with the use of online debit cards is the necessity to have an electronic authorization device at the point of sale (POS). In most countries, the authorization device takes the form of a keypad to enter the PIN, the device being permanently connected via telephone line or wirelessly to one or more banks. Overall, the online debit card is generally viewed as superior to the offline debit card because of its more secure authentication system and live status, which alleviates problems with processing lag on transactions. Offline debit cards carry the logos of major credit cards (for example, Visa or MasterCard) or major debit cards (for example, Maestro in the United Kingdom and other countries) and are used at the point of sale like a credit card, with payer's signature. This type of debit card may be subject to a daily limit, and/or a maximum limit equal to the current check account balance from which it draws funds. Transactions conducted with offline debit cards require two to three days to be reflected in users' account balances. Banks and merchant service organizations may charge transaction fees for the use of debit cards. Another difference between online and offline debit cards is that online debit purchasers may opt to withdraw cash in addition to the amount of the debit purchase (if the merchant supports that functionality) and merchants normally pay lower fees for online transactions compared with those for offline transactions. The risk from the lower level of security of offline debit cards is mitigated by the transaction limits imposed upon these cards. Debit cards may operate using the magnetic stripe system or contactlessly, as a chip and pin card. An example of a multi-application debit and credit card is that developed by HSBC and Oberthur, in which a consumer chooses the preferred payment method at the point of sale using a single PIN. The primary default payment (credit or debit) application is determined by the card issuer and is represented in the traditional way with the card number on the front and the card security code next to the signature strip on the reverse of the card. This is also the primary payment application encoded on the magnetic stripe for use in non-EMV countries. The card number of the secondary payment application is printed non-embossed on the reverse of the card beneath the magnetic stripe, with the card security code alongside. The cardholder name, start and expiry date are the same for both payment applications so that both the debit and credit functions are available for use online and over the telephone.

Proximity cards were developed as an easy and convenient means of gaining access to secure situations. Held near an electronic reader for a moment they enable the identification of an encoded number. The reader usually produces a beep or other sound to indicate that the card has been read. Proximity cards typically have a read range of up to 50 cm and can often be left in a wallet or purse and read by simply holding the wallet or purse near the reader. Proximity cards operate on the older 125 kHz frequency, rather than the 13.56 MHz of contactless smartcards. Contactless smart cards can be made to have similar functionality to a proximity cards, although simple proximity cards hold no more data than a magnetic stripe card. Passive 125 kHz cards are powered by radio frequency signals from the reader device and, having a limited range, must be held close to the reader unit. They are principally used as keycards for access control doors in office buildings. Active 125 kHz proximity cards, sometimes called vicinity cards, are powered by an internal lithium battery. They can have a greater range of up to two meters and, using UHF frequencies, the range can be extended up to 150 meters, often being used for applications requiring the card to be read inside a vehicle, such as the opening of security gates or automated toll collection. The internal batteries of active proximity cards eventually run down and the cards must be replaced after a number of years.

In operation, the proximity card and the reader unit communicate with each other through 125 kHz radio frequency fields, by resonant energy transfer. The card has three components, sealed between plastic layers: an antenna consisting of a coil of wire, a capacitor, and an integrated circuit (IC), the integrated circuit containing the user's ID number in specific formats and no other data. The reader unit has its own antenna, which continuously transmits a short range radio frequency field. When the card is placed within range of the reader unit, the antenna coil and capacitor, forming a tuned circuit, absorb and store energy from the field. The energy is rectified to direct current which powers the integrated circuit. The chip sends its ID number or other data to the card antenna coil, which transmits it by radio frequency signals back to the reader unit. The reader unit verifies that the ID number transmitted from the card is correct, and then performs whatever function it has been programmed to do. Since all the energy to power the card comes from the reader unit, passive cards must be close to the reader unit to function, and so have only a limited range. The lithium cell of an active card allows amplification of the signal from the reader unit, and thus for the reader unit to be detected at a greater distance. The battery also powers a transmitter circuit in the chip, making it possible to transmit a stronger return signal over a greater distance.

Driven by the high level of fraud associated with magnetic stripe cards, a higher level of security was sought in creation of the EMV system operating with a chip and PIN card. EMV cards may be contactless or operate by direct contact via a contact module such as that seen on most modern cards. For contactless operation, antennas are present in both POS terminal and the card, the terminal generating a 13.56 MHz carrier signal that powers the card and carries the data, the modulation used to transmit data varying according to the type of card. EMV standards specify interoperability between EMV-compliant IC cards and EMV-compliant credit card payment terminals throughout the world. Offering greater security of offline transactions, an original goal of the EMV system was to allow for both credit and debit card transactions to be conducted with a single card and for the card to be employed as an e-purse. The EMV (Europay-MasterCard-Visa) chip-based payment card contains a secure, embedded microprocessor that manages multiple applications in addition to storing, processing and highly protecting data such as cardholder identity, account information and more. The security features of chip technology, including encrypting personal data, locking access to data until the consumer authorizes access or the device reader authenticates itself to the chip, and encrypting communication between the reader and the chip, provide immunity to threats from skimming and eavesdropping as well as preventing unauthorized access to personal information. In the issuing of an EMV card, the customer's information is extracted from the issuer's database, the data is supplied to a data preparation system which adds additional data, including digital certificates and cryptographic keys, and finally, the data is written to the card chip (personalization). In an EMV transaction, the card is authenticated as being genuine, the cardholder is verified, and the transaction includes dynamic data and is authorized online or offline, according to issuer-determined risk parameters. Should fraudsters be able to steal account data from chip transactions, this data cannot be used to create a fraudulent transaction in an EMV or magnetic stripe environment, since every EMV transaction carries dynamic data. EMV can also address card-not-present (CNP) fraud, with cardholders using their EMV cards and individual readers to authenticate Internet transactions.

In an EMV card transaction, card authentication can take place on-line, with the issuer authenticating the transaction using a dynamic cryptogram, off-line with the card and terminal performing static or dynamic data, or both. All EMV cards have a mandated minimum requirement to use one card-unique 3DES (Triple Data Encryption Algorithm) key and have a choice between three increasingly secure usages of RSA (public key algorithm) signatures and keys: SDA (Static Data Authentication), DDA (Dynamic Data Authentication) and CDA (Combined Dynamic Data Authentication—25 Application Cryptogram Generation). The initial and most basic layer of crypto is the use of RSA signature to authenticate the payment card itself when it is used at the ATM and POS terminal. For SDA, the smart card contains application data which is signed by the private key of the issuer's RSA key pair. When a card with an SDA application is inserted into a terminal, the card sends this signed static application data, the CA index, and the issuer certificate to the terminal. The terminal verifies the issuer certificate and the digital signature by comparing these to the actual application data present on the card. In short, an RSA signature gives the assurance that the data is in fact original and created by the authorized issuer. SDA does not prevent replay attacks as the same static data is presented in every transaction. This is improved with DDA where the smart card has its own card-unique RSA key that signs dynamic data, i.e.: unpredictable and transaction-dependent data, and sends this to the terminal. When a card with a DDA application is inserted into a terminal, the card sends the signed dynamic application data, the CA index, the issuer certificate and the card certificate to the terminal. The terminal then verifies the issuer certificate, the smart card certificate and the signed dynamic application data. The SDA and DDA schemes both suffer from protocol weaknesses that may be exploited for criminal purposes. The security mechanism in SDA is there to compare what is on the actual card (PAN, expiry date etc.) with signed data generated at the time of personalization. The digital certificate is a static certificate, i.e.: independent of the actual transaction, and hence could be subject to replay attacks. DDA is stronger and makes use of a card-resident unique RSA key to dynamically sign unpredictable data, unique to each transaction, in the form of a 32-bit number generated by the POS terminal. This, however, is only for the purpose of authenticating the card. The unpredictable data and the user PIN are important security elements in the transaction process. The EMV protocol for transaction approval or denial does contain more logical processing, and there is a potential weakness between the steps of verifying the card (using SDA or DDA) and the step of approving the actual transaction. Once the card has been approved, a subsequent step is for the card to validate whether the actual transaction shall be denied, approved, or sent online for issuer decision. The card makes that decision based on other card parameters, and it is possible to first go through the SDA/DDA process and then change the message from the card with the verdict on the transaction, although the latter does use card-generated cryptograms. A scheme has been devised that combines both the card authentication and the transaction approval decision in one step. The scheme is termed Combined Dynamic Data Authentication-Application Cryptogram Generation and is abbreviated to CDA. Essentially, it consists of including the card decision among the data being signed by the card's RSA key. An EMV card contains a (typically 16-bit) transaction counter that is incremented with each payment or chip authentication transaction and this is incorporated into the initial card response at commencement of the card verification process.

Cardholder verification is achieved in four ways (CVMs):
Online PIN, where the PIN is encrypted and verified online by the card issuer; Offline PIN, where the PIN is verified offline by the EMV card;
Signature verification, where the cardholder signature on the receipt is compared to the signature on the back of the card;
No CVM, where none is used (typically for low value transactions or for transactions at unattended POS locations.
   Depending on payment brand rules and issuer preference, chip cards are personalized with one or more CVMs in order to be accepted in as wide a variety of locations as possible. Different terminal types support different CVMs. For example, attended POS devices, in addition to supporting signature, may support online or offline PINs (or both), while some unattended card-activated terminals may support “no CVM.”

EMV transactions can be authorized on-line or off-line. For an on-line authorization, transaction information is sent to the issuer, along with a transaction-specific cryptogram, and the issuer either authorizes or declines the transaction in real time. In an offline EMV transaction, the card and terminal communicate and use issuer-defined risk parameters that are set in the card to determine whether the transaction can be authorized. Off-line transactions are used when terminals do not have online connectivity (e.g.: at a ticket kiosk) or in countries where telecommunications costs are high. Cards can be configured to allow both online and offline authorization, depending on the circumstances. Most EMV transactions are authorized online.

While the functions of card authentication, cardholder verification and transaction authorization are fundamental to the operation of the EMV card system, the system incorporates extensive and complex functionality. For a number of commercial and technical reasons, EMV cards incorporating magnet stripe technology and chip and signature are still in common use.

Cards supporting several functions are known. In the combined debit/credit card and associated payment authorization/processing method taught by Goldman in US 2005/0240527, the customer is offered election of a credit feature or a debit feature. If debit is selected, the customer enters a personal identifier (PIN). In a further transaction, the process investigates the authorization request to determine whether or not a PIN field contains a PIN value or any field or field entry that may indicate that a “personal identification indicator” was entered at the point of sale. If a personal identifier is present, the transaction is authorized against the available balance in the customer's debit (e.g.: check) account. If the PIN is absent, the transaction is authorized against the available credit on a connected line of credit. Alternatively, in both selections, the customer enters a personal identifier and selects a Credit or Debit option.

A financial card taught by Kim in KR20140109202 is linked with and provides information about many affiliated companies providing various services. However, a user may have difficulty in remembering such information, making it sometimes inconvenient for him/her to use the card. And, should the user access the internet seeking information, it may be difficult to locate contents appropriate to him/her by accessing a corresponding home page. Therefore, the financial card of the user is provided with an NFC function having a uniform resource locator (URL) which enables the user to access a site on the internet corresponding to the financial card by means of a very simple operation. This is very convenient to the user and advantageous to a financial card company because of increased card utilization rate, affiliated companies and service providers being economically advantaged because of increased card utilization rate.

In the multicurrency card taught by Strauss in WO 2014/207460, a method is provided for maintaining a multicurrency card for use with a processing scheme for processing transactions, the multicurrency card being associated with a plurality of currencies, each of which is associated with a respective wallet capable of representing funds in its respective currency. The processing scheme is configured so as to preferentially debit, for a transaction, the wallet associated with the currency of the transaction, the method comprising inhibiting the crediting of the balance of a subset of the wallets associated with the plurality of currencies such that the balance for each of said subset of wallets is less than or equal to a predetermined amount irrespective of the currency of credit credited to the multicurrency card.

The multi-purpose transactional platform taught by Jorgensen et al in U.S. Pat. No. 8,768,830 is able to consolidate a plurality of a consumer's payment and non-payment source accounts into a consolidated platform with a customer identification or available proxy account numbers that can be assigned to source accounts. The source accounts can be, for example, credit card accounts, ATM accounts, debit card accounts, demand deposit accounts, stored-value accounts, merchant-loyalty card accounts, membership accounts, and identification card numbers. The consumer can access and modify any of the source accounts and manage funds across the source accounts by accessing the consolidated platform with a single access device or mode.

The multi-functional credit card-type portable device taught by Wyatt in US 2014/0263627 includes a credit card device capable of generating a programmed magnetic field of alternating polarity based on a speed of a card swipe, and methods for constructing the device for the purpose of emulating a standard credit card. An apparatus is described to allow said device to emulate behavior of a credit card when used in electronic credit card readers. Additionally methods are described to allow user control of said device for the purpose of authorizing or controlling use of said device in the application of credit, debit and cash transactions, including cryptocurrency and card-to-card transactions. Methods are also described for generating a limited-duration credit card number when performing a transaction, which is limited in scope of use to a predetermined number of authorized transactions. Furthermore said device may interact with other similar devices in proximity for the purpose of funds or credit/debit transfers.

The card having debit and credit functions taught by Park in KR 20140055200 can be used as a credit card and a debit card, its multi-functionality enabling easier storage and usage. The integrated card includes: a plate which has the name of the user and the serial number engraved on a surface; a hologram sticker for fraud prevention; a first magnetic tape which is arranged on the other surface of the plate and includes the serial number of the card and user information to be used for credit card payment; and a second magnetic tape which is arranged on the other surface of the plate with a predetermined space from the first magnetic tape, the second tape including serial number of the card and user information to be used for debit card payment.

The sightseeing function membership card combined electronic money and payment system taught by Lee in KR 20040019659 allows easy checking of a user by printing a photograph of the user in an RF IC card with a membership function and to enable a member to execute an inquiry and a prepayment/deferred payment calculation according to payment method selections of the member by supplying an electronic money function. The multifunction electronic money executes a debit card and credit card function and has a membership function for sightseeing and a royalty accumulation and use function. A commonly used terminal judges a right for using an institution out of the membership information, decides a service and a financial payment condition, inquires and charges a card, and records a royalty using the electronic money. An accounting server transmits accounting data, including a royalty, a card number and a charged amount of money with respect to the electronic money being supplied from the terminal through an on-line connection, and manages corresponding accounting data. A managing server receives user information, member store information, transaction details, and royalty information as to the terminal and the user from the accounting server and manages the information. A value added network accounting server receives accounting data being supplied from the accounting server through a communication network, processes an accounting from each payment institution, and returns the result to the accounting server.

In the combined charge account and credit/ATM card taught by Khalid et al in US 2007/0164098, a unique method and system is provided in which multiple accounts can be combined and a user can access them from a single master account. The account holder or organization offering the master account can define rule(s) maintained in a configurable table. Those rules dictate how a single transaction made to the master account can be executed using the combination of master account and child account(s). This technique enables a user to manage multiple accounts using a master account and an ATM Debit/Credit card associated with the master account, making the universal card concept a reality. Such a card is just like a regular card, compatible with existing systems and usable wherever regular cards can be used without any added difficulties. Also disclosed is a technique to encode or decode a sequence of transactions originated within a time segment to retrieve extra information that can be associated with the account.

In the method and apparatus to process combined credit and debit card transactions taught by Fleischl in U.S. Pat. No. 6,038,552, a method and apparatus for executing a transaction using a credit card includes the steps of: maintaining a credit card account associated with the credit card, the credit card account having a credit limit and a transaction balance indicative of an aggregate of previously authorized transaction amounts in a predetermined period; maintaining a cash account associated with the credit card, the cash account having a cash balance; receiving a request for authorization for a new transaction amount against the credit card account in exchange for goods or services; and authorizing the requested transaction amount when the aggregate of the credit limit and cash balance less the transaction balance exceeds the requested transaction amount.

In the programmable card taught by Evans in US 20120023024, a payment device is programmed to be in the same form factor as a typical credit or debit card and can be programmed and reprogrammed with various payment profiles. The payment device is interfaced with a mobile device, such as through insertion into a module capable of holding the payment device within proximity to a main housing of the mobile device. The payment device can include both a magnetic stripe and an IC chip which is capable of near field communication. In embodiments of the invention, the mobile device, such as a cellular phone, includes a memory element. The memory element securely stores payment profiles of financial accounts which are commonly found on credit, debit, gift, transit and loyalty cards. When a payment profile stored in the memory element of the mobile phone is selected, the mobile phone writes the profile onto the payment device. The payment device can then be utilized to communicate payment profile information to a payment device reader during contact or contactless transaction.

An example of a modem, multifunction card is the widely-used Multos multi-application smart card operating system. The Multos system enables a smart card to carry a variety of applications, from chip and pin application for payment, to on-card biometric matching for secure ID and ePassport. Multos smart card technology delivers high security, interoperable platforms for any application and consists of two unique technologies that deliver the secure architecture—the on-card virtual machine that securely executes applications and the Multos security scheme, an implementation of Secure Trusted Environment Provisioning (STEP) technology that secures the smart card, application code and application data. STEP is a patented mechanism by which the manufacture, issuance and dynamic updates of Multos smart cards in the field is entirely under the issuer's control. This control is enforced through the use of a Key Management Authority (KMA). The KMA provides card issuers with cryptographic information required to bind the card to the issuer, initialize the card for use, and generate permission certificates for the loading and deleting of applications under the control of the issuer. Multos smart cards have been issued by banks and governments all around the world, for applications ranging from contactless payment, internet authentication and loyalty, to national identity with digital signature, ePassport with biometrics, healthcare and military base and network access control.

A Multos implementation provides an operating system upon which resides a virtual machine. The virtual machine provides:
Application run-time environment.
Memory management.
Application loading and deleting.

### Run-Time Environment

The run-time environment operates within the application space. This consists of code space and data space. The code is assembled and is interpreted every time it is executed. The virtual machine performs code validity and memory access checks. The data space is divided into static and dynamic portions. The key component of dynamic memory is the last in, first out (LIFO) stack as this makes using the various functions much easier. A Multos chip is a stack machine, which makes use of this dynamic memory to pass parameters and perform calculations. In addition, the input/output buffer resides in another dynamic memory segment.

### Memory Management

Each application resides with a rigorously enforced application memory space, which consists of the application code and data segments. This means that an application has full access rights to its own code and data, but can not directly access that of another application. If an application attempts to access an area outside its space, it results in an abnormal end to processing.

### Application Loading and Deleting

A Multos card permits the loading and deleting of applications at any point in the card's active life cycle. A load can take place once the application and its corresponding certificate are transmitted to the chip. A delete is permitted if a certificate that corresponds to a loaded application is transmitted to the chip.

### Secure Multi-Applications

Multos applications are developed in high-level languages such as ‘C’ or Java (or in low-level assembly language) and compiled into MEL bytecodes that are executed by the virtual machine. When an application executes, the virtual machine checks each and every bytecode instruction to ensure it is valid and properly formed. All memory areas accessed by the instructions are also checked that they are within the memory area of that application. Any invalid instructions or attempted memory accesses are rejected by the virtual machine and all smart card application execution will stop. The execution-time checking ensures the complete safety of application execution and data—it is not possible for an application to access the data of another application on the smart card. As application data sharing is not permitted, application providers can be assured that their data is safe from other applications that may reside alongside theirs in the smart card.

Smart cards have also found extensive use throughout the world for identification purposes. Such cards are able to store biometric data, including images, fingerprints, iris images, the geometry of a hand, finger, or thumb, or of some pattern of the person's behavior, such as the dynamics of signature-writing or password-typing. The biometric can then be used to test whether the person presenting the card is likely to be the same as the person to whom it was issued. It could also be used as a means of unlocking the encryption keys stored on the same chip. Identification smart cards are also able to store historical data relating to attendance by card holders at places where cards are employed for access purposes. Another large-scale application for smart cards is the almost ubiquitous loyalty card.

Notwithstanding the fact that smart cards are now able to host multiple functions, there is no true universal card able to provide functionality encompassing all those of commonly employed cards for a broad spectrum of applications.

### SUMMARY

The first object of the present invention is thus to provide what is, effectively, a universal card able to support the functionalities of most commonly employed (individual) cards and which may be employed to execute the full spectrum of transactions available from the individual cards. A second object of the present invention is to provide a system permitting the ready loading of a number of functionalities from individual cards, to be stored as virtual cards in the universal card and to be available for use, as required, via the universal card. A third object of the present invention is to provide means to readily switch the universal card from one individual card functionality to another. A fourth object of the present invention is to be able to transfer stored value to/from an individual card from/to a virtual debit card or e-wallet in the universal card.

According to the present invention, a universal card system comprises a universal card and a functionality transfer unit (FTU). Said universal card is preferably made in the well-known laminated form with the normal dimensions of a credit card and with a more or less plain external surface carrying only a serial number, a magnetic stripe and a contact module. Internally, said universal card comprises one or more microprocessors; a suitable rechargeable battery, battery charging means, one or more aerials, electrical current collection means, a contact module, and a magnetic stripe. All by suitable data-carrying or electrical current supplying circuitry, and as appropriate, said aerials are connected to said microprocessors; said aerials are also connected to said electrical current collection means; said electrical current collection means are connected to said battery charging means; said battery charging means are connected to said battery; said battery is connected to said microprocessors; said contact module is connected to said microprocessors; and said contact module is also connected to said battery charger.

The (FTU) comprises a case having a suitably shaped recess to wholly or substantially accommodate said universal card or any conventional card of whatever type; one or more microprocessors with suitable memory capacity; a contact module within said case positioned to make contact with the contact module of a card positioned in said recess; one or more aerials positioned adjacent the upper surface of said case; a suitable battery and charger; a power supply unit supplied with electrical current from a mains supply; a miniaturized finger pad; a display; a keyboard and three or more control buttons. To this is added an external, detachable magnetic stripe reader. All by suitable data-carrying or electrical current supplying circuitry, and as appropriate, said contact module is connected to said microprocessors; said aerials are connected to one or more of said microprocessors; said battery is connected to one or more of said microprocessors; said battery charger is connected to said contact module (for the purpose of charging said universal card battery); said power supply unit is connected to said battery charger; said finger pad is connected to one or more said microprocessors; said display is connected to one or more said microprocessors; said keypad is connected to one or more said microprocessors; said control buttons are connected to one or more said microprocessors; said keypad is connected to one or more said microprocessors; and said magnetic stripe reader is connected to one or more said microprocessors. Said control buttons are preferably ‘On’ and ‘Off’ buttons for powering up and powering down said FTU, with a single ‘Execute’ button for initiating commands.

In operation, an individual card's data may be read by said FTU in contactless mode via said aerials or in contact mode via said contact modules (the individual card may also receive data from said FTU using the same modes). Similarly, said individual card may be powered from said FTU via said contactless or contact modes or an internal battery of said card may be charged via the said modes. Said internal battery of said FTU is charged via a charging circuit and battery charger powered from a mains current supply to an internal power supply. To load its functionality into said universal card, a said individual card is inserted into said FTU and read in the appropriate mode (or its magnetic stripe is read in said external magnetic stripe reader). Command inputs for said reading are delivered to said FTU preferably via a stylus applied to said finger pad to scroll though commands appearing in said display to select a ‘Read’ command and by executing the selected command by pressing said ‘Execute’ button. As appropriate, a request may appear for the inputting of a PIN number or other security code and this is inserted via said keyboard. The functionality data read from said individual card is, thereafter, held in memory in said FTU, preferably in one of a plurality of discrete memories of said microprocessors. To transfer said functionality data from said FTU to said universal card, said universal card is inserted into said FTU, the appropriate card functionality is selected and confirmed in said display, a ‘Write’ command is selected in said display and executed by pressing said ‘Execute’ button. Illumination of a light-emitting diode, sounding of an audible tone or appearance of a message in said display (all in said FTU) is employed to confirm completion of the ‘Write’ command. While the reading of most card types is straightforward, in the case of cryptographically-protected cards, an analytical process is initiated by said ‘Read’ command, said analytical process extracting the normally inaccessible data from the EMV card by performing, essentially, an attack of one of the well known types. Said universal card is designed to accommodate multiple functionalities, including, for example, credit and debit card, or credit card and secure space access card.

### BRIEF DESCRIPTION OF THE DRAWINGS

The various aspects of the present invention will be more readily understood by reference to the following description of preferred embodiments given in relation to the accompanying drawings in which:

FIG. 1 is a view of the face of said universal card;

FIG. 2 is a view of the reverse of said universal card;

FIG. 3a is a view of the pivoting upper cover of an embodiment of said functionality transfer unit;

FIG. 3b is a view of the hinged end of the functionality transfer unit of FIG. 3a;

FIG. 3c is a view of the opening end of the functionality transfer unit of FIG. 3a;

FIG. 4 is a schematic diagram of the internal components of an embodiment of said functionality transfer unit;

FIG. 5 is a schematic diagram of the internal components of an embodiment of said universal card;

FIG. 6 is a view of an embodiment of the functionality transfer unit of FIG. 3a with its cover opened.

### DETAILED DESCRIPTION

In the following, a card, other than said universal card, is referred to as an individual card.

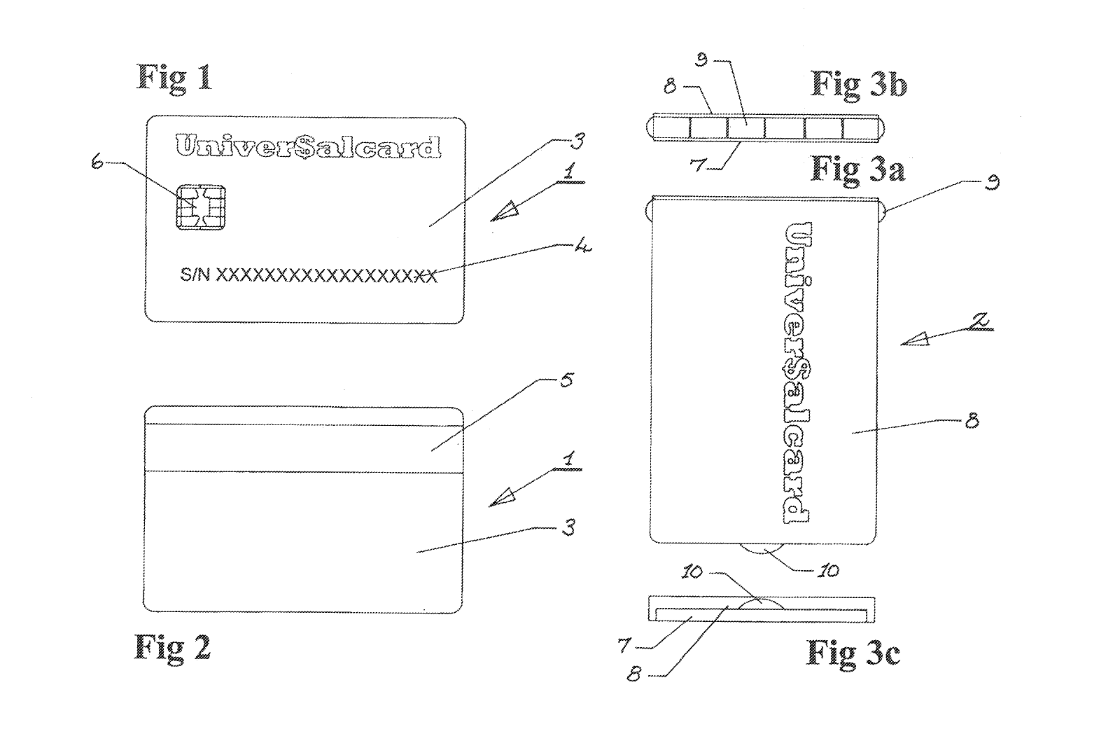

With reference to FIGS. 1, 2, 3a, 3b and 3c, a universal card system comprises a universal card 1 and a functionality transfer unit 2. Said universal card comprises a body part 3 preferably made in the well-known laminated form and having the normal dimensions of a credit card and a more or less plain external surface carrying only a serial number 4, a magnetic stripe 5 and a contact module 6. With additional reference to FIG. 5, internally, said universal card comprises one or more microprocessors 16; a suitable rechargeable battery 21, battery charging means 20, one or more aerials 18, electrical current collection means 19, a contact module 17, and a magnetic stripe 5. Said aerials are configured or configurable to work at the two common card frequencies of 125 kHz and 13.56 MHz. In an alternative embodiment, said universal card is configured to work with the larger range, Gen 2 UHF cards working with frequencies in the range 860-960 MHz or other proprietary cards. Said microprocessors are able to generate the outputs necessary to perform all normal individual card functions and optionally takes the form of a single chip controlling the communication interfaces or separate chips attached to each interface (hybrid card). In an alternative embodiment, said microprocessor is based upon a multi-core chip with suitable memory management. Electrical current collection means 19 comprise a capacitor and rectification means (not shown). When said aerial is exposed to a suitable radio-frequency field, said antenna and said capacitor form a tuned circuit and electrical power is received by resonant energy transfer. Electrical current flowing to said capacitor is rectified and supplied to said battery charging means and thence to said battery. Said battery charging means monitor the charge state of said battery and, when it is fully charged, interrupt the flow of charging current. Having an internal battery, said card is an Active Card. In an alternative embodiment (not shown), said universal card is a Passive Card in which electrical current collection means supply current directly to said microprocessors. The communication range and rate of data transfer of a passive card may be inferior to those of an active card. In the schematic diagram depicted in the figure, said aerials are connected to said microprocessors by circuit 22; said aerials are also connected to said electrical current collection means by circuit 23; said electrical current collection means are connected to said battery charging means by circuit 24; said battery charging means are connected to said battery by circuit 25; said battery is connected to said microprocessors by circuit 26; said contact module is connected to said microprocessors by data circuit 27; said contact module is connected to said microprocessors by electrical current-carrying circuit 28; and said contact module is also connected to said battery charger by electrical current-carrying circuit 29. Said universal card is thus able to be powered as a passive or active card. Said battery is able to be charged contactlessly, by induction, from said functionality transfer unit or by direct contact from said FTU. Data generated by said microprocessors is transmitted to said aerials via circuit 22 or to said contact module via circuit 27. In other alternative embodiments (not shown), said universal card incorporates a fingerprint sensor or generates a one-time password (displayed on said display) for on-line banking applications. Magnetic stripe 5 (position on reverse side of card indicated in broken line) is rewritable and acts only as a passive data recording medium, to which data is written and from which data is subsequently read.

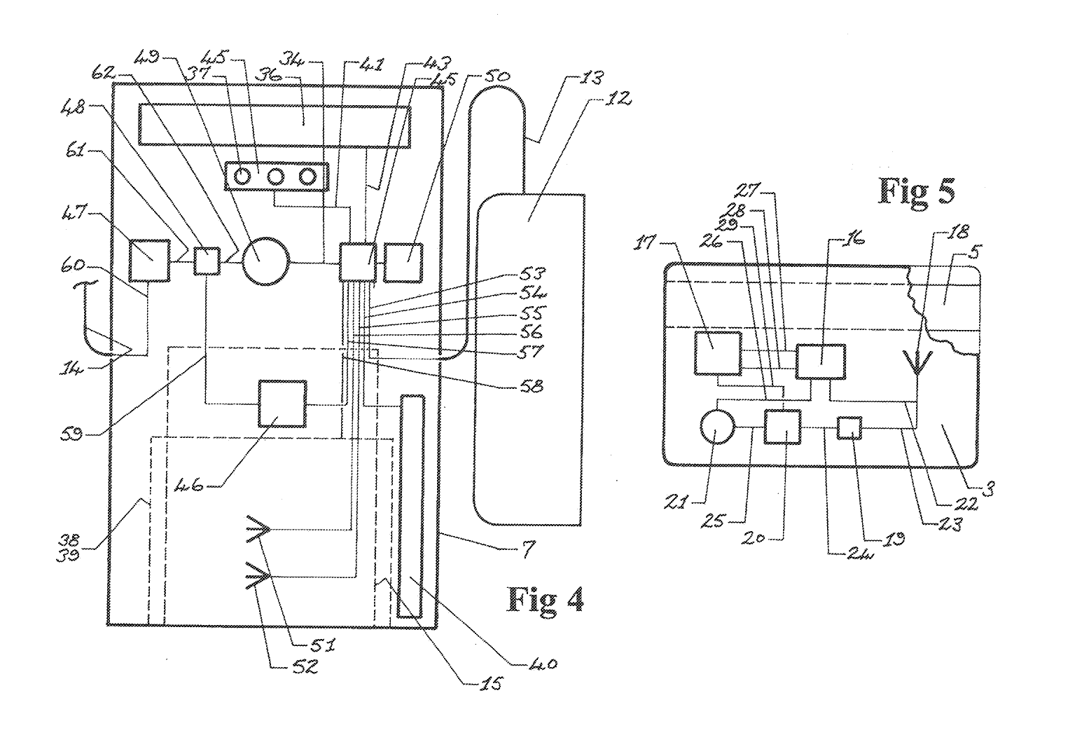

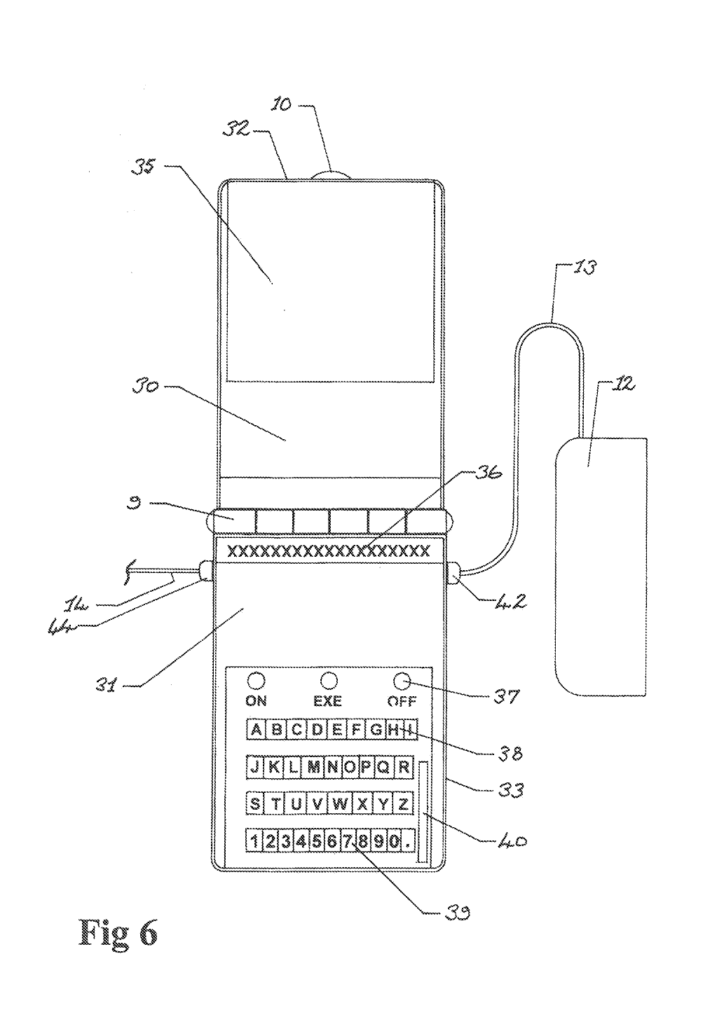

With additional reference to FIGS. 4 and 6, functionality transfer unit (FTU) 2 comprises a body part 7 closed by a clam-shell-type cover 8 which is pivotally attached to one end of said body part by hinge 9, a finger grip 10 being formed in the free end of said cover to facilitate its manipulation and circumferential flanges 32, 33 provided around, respectively, the edges of said cover and said body part, being made such that one passes inside the other in a light interference fit, thereby preventing the ingress of dust; one or more microprocessors with suitable memory capacity 45, 50; contact module 46; power supply 47; battery charger 48; battery 49; display 36 able to display a minimum of 15 characters; one or more aerials positioned adjacent the upper surface of said case 51, 52; miniaturized finger pad 40; three or more control buttons 37; and keyboard containing alphabetical and numerical keys 38, 39. To this is added an external, detachable magnetic stripe reader 12 connected to said body part by cable 13 and miniature USB plug 42. Said power supply is connected to a mains power source by cable 14 connected to said body part by miniature 2-pin plug 44. In the embodiment depicted in FIG. 6, said universal card or an individual card is read from or written to by being placed in recess 35 and inserted beneath bridge 30 incorporated into the inner surface of said FTU cover, said recess and said bridge being exposed by the opening of said cover. Said bridge incorporates on its inner surface a contact module (not shown) and a leaf spring or the like (not shown) provided in said cover beneath said bridge acting to urge a said card against said contact module to ensure a good electrical contact. Recess 31 is provided in said FTU body part to accommodate said bridge when said cover is closed. In the embodiment depicted in FIG. 4, said universal card or an individual card is read from or written to by being inserted into a recess (location depicted in broken line as 15) shaped to wholly or substantially accommodate said universal card or any individual card of whatever type, the upper surface of said recess incorporating a contact module (not shown), a leaf spring or the like (not shown) provided in the lower surface of said recess acting to urge a said card against said contact module to ensure a good electrical contact.

In the schematic diagram depicted in FIG. 4, said contact module is connected to said microprocessors by data circuit 57; said aerials are connected to one or more of said microprocessors by data circuits 56, 55; said battery is connected to one or more of said microprocessors by circuit 34; said battery charger is connected to said contact module by circuit 59 (for the purpose of charging said universal card battery); said power supply is connected to said battery charger by circuit 61; said battery charger is connected to said battery by circuit 62; said finger pad is connected to one or more said microprocessors by circuit 54; said display is connected to one or more said microprocessors by circuit 43; said keypad is connected to one or more said microprocessors by circuit 58; said control buttons are connected to one or more said microprocessors by circuit 41; and said magnetic stripe reader is connected to one or more said microprocessors by circuit 53. Said control buttons are preferably ‘On’ and ‘Off’ buttons for powering up and powering down said FTU, with a single ‘Execute’ button for initiating commands, in the preferred embodiment, said buttons forming part of a module 45. In the embodiment depicted in FIG. 4, said keypad is exposed, fixed to the upper surface of said body part, its position indicated in broken line as 38, 39. In an alternative embodiment (not shown), said microprocessors draw electrical current directly from said power supply.

Said battery in said universal card is charged in contactless mode by placing said card on said FTU, or in contact mode by inserting said card into said FTU, scrolling through the legends in said display to select, ‘Charge Unicard’, and pressing the ‘Execute’ button. Said display shows the legend, ‘Card Charged’, when the charging process is complete. In an alternative embodiment (not shown), illumination of a light-emitting diode or sounding of an audible tone is employed to signify the fully charged state of said battery.

In operation, a card's data may be read by said FTU in contactless mode via said aerials simply by being placed on said FTU; or in contact mode via said contact modules; the card also being able to receive data from said FTU using the same modes. Similarly, said card may be powered from said FTU via said contactless or contact modes, or from said internal battery of said card charged via said modes. Said internal battery of said FTU is charged via said battery charger powered from a mains current supply to said internal power supply.

To load the functionality of an individual card into said FTU, said FTU is powered up by pressing said ‘On’ button. When said FTU is booted up, a stylus, matchstick or the like is applied to said miniaturized finger pad and the operator scrolls through the legends in said display and selects, ‘Copy Card’. The operator then presses the ‘Execute’ button and the query, ‘What Card?’ appears in said display. Again using said finger pad, the operator scrolls through the card types appearing in said display to find the appropriate one and again presses the ‘Execute’ button. If the type of card selected in said display is a magnetic stripe individual card, the command, ‘Swipe Card Now’ appears in said display. The operator then swipes the card through said magnetic stripe reader and, if the reading is properly performed, the legend, ‘Reading OK’, appears in said display, indicating that the data read from said individual card is resident in memory in said FTU. The operator again presses the ‘Execute’ button and the legend, ‘Write Unicard?’, appears in said display. The operator inserts ‘Y’ (for yes) or ‘N’ (for no) from said keyboard and again presses the ‘Execute’ button. If ‘Y’ has been selected, the command, ‘Swipe Unicard’, appears in said display. The operator then swipes said universal card through said magnetic stripe reader. The legend, ‘Swipe Again’, appears in said display and the operator again swipes the card. If the writing has been properly performed, the legend, ‘Writing OK’, appears in said display, indicating that the data read from said FTU has been properly written to the magnetic stripe of said universal card. In all cases, where the functionality of an individual card is being loaded into said universal card, following an affirmative response to the command, ‘Write Unicard?’, the command, ‘Card Name?’, will appear in said display. Using said keyboard, the operator will insert a four or five-character name, such as VISA 1 for a first Visa card, or AMEX for an American Express card in said display and press said ‘Execute’ button.

Where the type of card initially selected in said display is a proximity individual card, the command, ‘Read Card Now’ appears in said display. The operator then either places the individual card on said FTU to be read in contactless mode or inserts the card into said FTU to be read in contact mode and presses the, ‘Execute’ button. The card is read by said FTU and, if the FTU requires a PIN number or other access code, the legend, ‘Code?’, appears in said display. The operator enters the code via said keyboard and again presses the ‘Execute’ button. If the PIN or access code is entered correctly and the reading is properly performed, the legend, ‘Reading OK’, appears in said display, indicating that the data read from said individual card is resident in memory in said FTU. The operator again presses the ‘Execute’ button and the legend, ‘Write Unicard?’, appears in said display. The operator selects ‘Y’ (for yes) or ‘N’ (for no) from said keyboard and again presses the ‘Execute’ button. If ‘Y’ has been selected, the command, ‘Present Unicard’, appears in said display. The operator then either places the universal card on said FTU to be written in contactless mode or inserts the universal card into said FTU to be written in contact mode and presses the, ‘Execute’ button. The FTU writes to the card and checks the written data, if the data check is positive, the legend, ‘Writing OK’, appears in said display, indicating that the data from said FTU has been properly written to said universal card.

Transferring functionality of an EMV card to said universal card (replication) similarly involves an analytical process. As described previously, after positioning the individual card to be read, the operator selects the card type in said display and presses the ‘Execute’ button. The legend, ‘Analyzing’, appears in the display and said FTU automatically conducts an analytical process to extract the normally inaccessible data from the EMV card. Said analytical process involves the performance of one or more attacks of well known types, commencing with the most straightforward and progressing to more complex attacks, as circumstances require. In the preferred embodiment, said analysis is managed by a dedicated microprocessor. Said microprocessor is loaded with an EMV card browser, various forms of which are well known, and which allow reading of the contents of the chip on a Chip and PIN/EMV smart card. In the simplest and most straightforward attack, said FTU imitates a merchant point-of-sale (POS) card reader and processes a number of zero-value, dummy transactions. Knowing the input data, the challenges generated by the imitation POS card reader, the PIN, and the responses generated by the card in the series of dummy transactions, may permit prediction of the unique, unpredictable, 32-bit single-use number generated for each transaction. This is the result of the fact that some EMV implementers have merely used counters, timestamps or home-grown algorithms to generate the unique number. This ‘pre-play’ attack is a known vulnerability of EMV cards, allowing reading of data from a card and, effectively, the cloning of that card by authentication of another card as the original card. Data derived from the replication process is carried in memory in said FTU and, as required, is written to said universal card in the manner described. Where this method is employed to copy an EMV card, the transaction counter normally incremented with each payment or chip authentication transaction is reset to the position existing in the card at the time of its replication. The universal card is only able to be used to make the number of transactions equal to the number of dummy transactions made on the original card during the replication process and, to avoid rendering the original card unuseable, the replication process must then be re-run. Alternatively, the universal card can be made to permit continuous transactions and the original card is no longer used. Should the ‘pre-play’ attack fail to allow replication of an EMV card, another method is available to create a functional clone containing the necessary credit card data as well as pre-played authorization codes. The clone card, which is the universal card, can then be used to perform EMV magnetic stripe transactions at any EMV contactless payment terminal. In this method, preferably conducted as an automated process by a dedicated microprocessor in said FTU, the attack does not need to rely on issues in terminal implementations. The unpredictable numbers used in the COMPUTE CRYPTOGRAPHIC CHECKSUM command are systematically weakened by the protocol design. As a result of this design flaw, the possible range of unpredictable numbers is greatly reduced. The “Unpredictable Number (Numeric)” field used in COMPUTE CRYPTOGRAPHIC CHECKSUM is a 4-byte value. Consequently, in theory, the number could range from 0 to 4,294,967,295 (2³²-1). However, the EMV Kernel 2 specification limits the contents of this field to a BCD (binary coded decimal) encoded numeric value. BCD is an encoding where the digits of a decimal number are used as digits in a hexadecimal number, each nibble of the 4-byte value holding one decimal digit. As a result, the unpredictable number can range from 0 to 99,999,999. However, the Mag-Stripe protocol further reduces the size of the unpredictable number to a number of bits set in the “Track x bit map for BMAPATC, UN, TRACKx, the bit mask that defines the positions within the discretionary data of track x where the unpredictable number and the application transaction counter will be embedded. Typical values encountered indicate that the unpredictable number may have, at most, 3 digits and is therefore in the range from 0 to 999. In order to generate dynamic CVC3s, the credit/debit card application must be selected and a sequence of GET PROCESSING OPTIONS followed by COMPUTE CRYPTOGRAPHIC CHECKSUM has to be repeated for every CVC3. With an average computation speed of 1,000 CVC3s per minute the attack requires approximately one minute of communication with an EMV magnetic-stripe card to pre-generate sufficient information for performing successful payment transactions. Data derived from the replication process is carried in memory in said FTU and, as required, is written to said universal card in the manner described. As mentioned previously, if the ATC+CVC3 sets generated during the attack are not reused by the original (alternative) card, the universal card can continue to be used in magnetic stripe mode.

Should a further replication method be required, the following method is preferably performed in a dedicated microprocessor as an automated process. In regions supporting the full Pay-Pass microchip protocol (EMV mode and magnetic stripe mode), if both, the card and the terminal, support EMV-mode, they will perform an EMV-mode transaction and will not fall back to magnetic stripe mode. Therefore, a clone card that contains a copy of all static card data and the pre-played list of UN+ATC+CVC3 sets will cause a terminal to perform an EMV-mode transaction which is not supported by that simple clone card. While this should only work for terminals supporting Kernel 2's magnetic stripe mode, tests with POS terminals reveal that terminals can be tricked into using the magnetic stripe protocol even though the original card supports EMV-mode. To do this, it is necessary only to change the application interchange profile contained in the response to the GET PROCESSING OPTIONS command. While the original application interchange profile would contain a flag indicating support for EMV-mode, the modified application interchange profile would have this flag cleared. To achieve this, the attacker simply sets the new application interchange profile to 0000. This is effective because magnetic stripe-mode does not provide any means to authenticate the data returned in response to the GET PROCESSING OPTIONS. As a result, it is possible to create a functional contactless magnetic stripe card with pre-played data extracted from a genuine card that supports EMV-mode, data derived from the replication process being carried in memory in said FTU and, as required, written to said universal card in the manner described. The clone card functionality is restricted to that of a Kernel-2-compatible contactless EMV card presented at any payment terminal accepting Kernel-2 cards.

In the creation of clone cards, the clone card Java Card application is useful. Said application runs on an NXP JCOP card and provides a rudimentary contactless EMV magnetic stripe interface and a second interface (“clone card interface”) to copy pre-play data onto the card. The EMV magnetic stripe interface responds with static data structures extracted from the transaction analysis in Appendix A for the commands SELECT PPSE, SELECT credit/debit application, and GET PROCESSING OPTIONS. By using the application interchange profile of a magnetic stripe card in response to the GET PROCESSING OPTIONS command, the clone card automatically performs the attack outlined in the immediately preceding section and does not advertise EMV mode capabilities. In response to the READ RECORDS command for the magnetic stripe data (record 1 of the elementary file with the short file ID 1), the clone card responds with a byte array that can be customized through the clone card interface. The clone card interface provides a command SET MAGSTRIPE DATA for this purpose. In response to COMPUTE CRYPTOGRAPHIC CHECKSUM, the clone card looks up the random number received from the POS terminal in a list of available UN+ATC+CVC3 sets and returns the ATC and the CVC3 codes. If no UN+ATC+CVC3 set is available for the given unpredictable number, the card returns the error code 6F00. The list of UN+ATC+CVC3 sets can be loaded into the card through the clone card interface's command SET MAGSTRIPE AUTH. After collecting the pre-play data from a real credit card, the Android application expects the user to tap a second card with the clone card interface. The Android application first stores the collected magnetic stripe data onto the clone card with the SET MAGSTRIPE DATA command. Then, the application stores all collected UN+ATC+CVC3 sets onto the clone card using the SET MAGSTRIPE AUTH command. In this method, said FTU takes the place of said second card, data derived from the replication process being carried in memory in said FTU and, as required, written to said universal card in the manner described.

Where the type of individual card initially selected in said display is, for example, a card based upon a cryptographically-protected, contactless memory chip, for example, the Mifare DESFire MF31CD4O, a so-called Side Channel attack is made. In this side channel attack, special equipment is employed to contactlessly record power signals from the chip and to analyze them to extract the chip cryptographic keys. When the technique (Correlation Power Attacks) was originally developed (2011), the equipment required to mount a side channel attack was complex and expensive. However, the technique is now well known and can be performed as a low-cost, automated process managed by a dedicated microprocessor. In transferring the functionality of this type of card to said universal card, as described previously, the operator positions the card to be read, selects the card type in said display and presses the ‘Execute’ button. The legend, ‘Analyzing’, appears in the display and the attack is automatically conducted in contactless mode by feeding data to said chip (stimulation), using an electromagnetic probe (not shown) to record the power signal taken by the chip, and to analyze the recorded signals. The legend, ‘Analyzing’, remains on view in said display until the process is completed, whereupon, the legend, ‘Analysis Complete’, appears, signifying that the extracted data is resident in memory in said FTU. As required, the extracted data is then written to said universal card in the manner described. In the preferred embodiment, the process of stimulation, recording by electromagnetic probe and analysis process is managed by a dedicated microprocessor. The electromagnetic probe forms part of said FTU and is connected to said dedicated microprocessor. Similarly, a low-bandwidth attack may be performed by measuring the electrical potential of a computer chassis or by measuring leakage from the ground wires at the remote end of VGA, USB or Ethernet cables, instead of using said electromagnetic probe.

Another side channel attack method that may be employed in a similar way to replicate an EMV card conducts an acoustic cryptanalysis key extraction attack. This method involves the recording of sound generated by a computer during decryption of selected ciphertexts—in this case, by stimulating an EMV card to generate responses as described in the immediately-preceding section. In a working computer, vibration of electronic components is sometimes heard as a faint high-pitched tone or hiss (commonly called “coil whine”, though often generated by capacitors). These acoustic emanations, typically caused by voltage regulation circuits, are readily correlated with system activity since CPUs drastically change their power draw according to the type of operations they perform. However, the bandwidth of these signals is very low: up to 20 kHz for audible signals and commodity microphones, and up to a few hundred kHz using ultrasound microphones. Cryptanalytic side-channel attacks typically require measurements with temporal resolution similar to the time scale of the target operation, but here the target cryptographic computation is many orders of magnitude faster (at the GHz scale). Despite the high frequencies involved and the faintness of acoustic signals of interest, full key recovery via acoustic cryptanalysis has been demonstrated to be feasible on common software and hardware. Cryptographic keys can be clearly distinguished by the sound made when they are used. In summary, the key extraction attack relies on crafting chosen ciphertexts that cause numerical cancellations, causing the special value zero to appear frequently in the innermost loop of the algorithm, where it affects control flow. While a single iteration of that loop is much too fast for direct acoustic observation, the effect is repeated and amplified over many thousands of iterations, resulting in a gross leakage effect that is discernible in the acoustic spectrum over hundreds of milliseconds. The key extraction attack requires decryption of ciphertexts adaptively chosen for the purpose. The RSA cryptosystem [RSA78], the key generation procedure, selects two random primes p, q of prescribed size, a (fixed) public exponent e, and a secret exponent d such that ed=1 mod φ(n) where n=pq. The public key is pk=(n, e) and the secret key is sk=(d, p. q). RSA decryption of a ciphertext c starts by computing c^{d} mod n. Modern RSA security standards mandate key sizes of at least 2048 bits (i.e., 1024 bit primes p, q) in order to achieve adequate levels of security [BBB+12]. Investigation of larger keys, of size 4096 bit (and 2048-bit primes), which should be secure beyond the year 2031 [BBB+12], have shown that an attack can extract whole 4096-bit RSA keys within about one hour using just the acoustic emanations from the target machine. The key extraction process uses an adaptive chosen-ciphertext attack, which exposes the secret factor q one bit at a time, from MSB to LSB. For each bit qi of q, starting from the most significant bit position (i=2048), it is assumed that key bits q2048 . . . qi+1 were correctly recovered, and a check is made of the two hypotheses about qi. Eventually, all of q and is learnt and, thus, the factorization of n is recovered. After recovering the top half the bits of q, it is possible to use Coppersmith's attack to recover the remaining bits, or to continue extracting them using the side channel. The same technique applies top. Similarly, the extracted data is resident in memory in said FTU and, as required, is written to said universal card in the manner described. In the preferred embodiment, said process of stimulation, acoustic recording and analysis is managed by a dedicated microprocessor having suitable memory capacity and management and analytical software. The microphone (not shown) used to record the acoustic signals forms part of said FTU and is connected to said dedicated microprocessor. In an alternative embodiment, said electromagnetic and acoustic side channel attacks and their associated processes of recording, analysis and cryptographic key extraction are performed in a separate module, plug-connectable to said FTU.

In another alternative embodiment, said electromagnetic and acoustic side channel attacks and their associated processes of recording, analysis and cryptographic key extraction are performed in a separate computer, the data so generated being transferred by cable to said FTU.

In another alternative embodiment (not shown), the case of said FTU is made large enough to fully enclose said universal card and protects it from being read contactlessly. Said case is optionally made of a light, stiff material, such as carbon fibre, and may incorporate a metal layer for screening purposes.

To change one individual card functionality loaded into said universal card for another, said universal card is inserted into said FTU, the legend, ‘Load Card’, is selected in said display and the ‘Execute’ button pressed. The legend, ‘which card?’, appears in said display. Using said keyboard, the operator inserts the appropriate card name, for example, AMEX, and presses the ‘Execute’ button. The functionality is thereby transferred from said FTU memory to said universal card.

In another alternative embodiment, provision is made for different card functionalities to be installed in said universal card and for each to become active at different times of a day or on different days of the week.

In another alternative embodiment, provision is made to transfer funds from or to said universal card to or from a stored value individual card (debit card), or from one stored value card to another. This is performed by placing the first card in said FTU and giving a command to deduct a specified amount. The second card is then placed in said FTU and a command given to credit the previously-deducted funds to said second card.

In the preferred embodiment, said universal card is linked to said FTU by a suitable password or security code and said universal card and said FTU can only be used as a pair.

In another alternative embodiment (not shown), a separate, external read/write/magnetic stripe reader unit is attached to a smart phone and said smart phone provides said functionality of said FTU.

In another alternative embodiment (not shown), a separate, external module is provided incorporating contact or contactless, read/write functions and magnetic stripe read/write functions, said module being attached to a smart phone and said smart phone providing said functionality of said FTU and said universal card.

In another alternative embodiment (not shown), where said smart phone provides said functionality of said FTU, QR codes are employed to validate the connection of said smart phone to said FTU for the purpose of transferring data from said FTU to said smart phone.

In another alternative embodiment, where said smart phone provides said functionality of said universal card, instead of inputting said password or security code to activate said universal card functions, said smart phone scans a QR code printed on cover 8 of said FTU.

In the preferred embodiment, said universal card can be deactivated by said FTU and can only be reactivated by using said password or security code.

In another alternative embodiment (not shown), said keyboard is made to pivot out from said case to facilitate access to it.

In another alternative embodiment (not shown), said universal card and said FTU are powered by photovoltaic panels.

In another alternative embodiment, said process of analysis and cryptographic key extraction of EMV cards is performed by a separate, trusted agency.

In the preferred embodiment, said FTU automatically de-powers itself after a pre-set period of inactivity, inputting of said password or security code being required to re-power it.

Additional applications for said universal card include, storage of medical records or storage of biometric data, including facial images, fingerprints, iris images, the geometry of a hand, finger, or thumb, or of some pattern of the person's behavior, such as the dynamics of signature-writing or password-typing. Biometric data may then be used to test whether the person presenting the card is likely to be the same as the person to whom it was issued. Similarly, biometric data may be employed to positively identify persons by law enforcement or security personnel. Biometric data might also be used as a means of unlocking the encryption keys stored on a device chip. Identification smart cards are also able to store historical data relating to attendance by card holders at places where cards are employed for access purposes.

Those skilled in the art will understand that the process descriptions given herein may lack fine detail and that many system permutations and combinations exist. They will also understand that many avenues are obviously available to finesse the methods described or to make them more efficient. Given that this is a rapidly moving field of technology, they will also understand that other such methods will be developed over time.

The scope of this invention should be taken to include any feasible combination of one or more systems, features or methods disclosed with any one or more other systems, features or methods disclosed.

1. A system to provide a multi-function transaction card comprising a card and a functionality transfer unit, said card being morphologically similar to conventional transaction cards and incorporating, externally, a magnetic stripe for transmitting data to and recording data from said functionality transfer unit and for the making of magnetic stripe-based transactions, and a contact module of the type normally used in conventional transaction cards for transmitting data to and from said functionality transfer unit, for receiving electrical current from said functionality transfer unit and for the making of contact-mode transactions; and, internally, one or more aerials to receive data and radio-frequency energy from said functionality transfer unit and for the transmitting of radio-frequency energy in the making of contactless-mode transactions, one or more microprocessors, a suitable rechargeable battery, battery charging means, and electrical current collection means, all said components being connected together, as appropriate, by suitable data-carrying or electrical current supplying circuitry; said functionality transfer unit comprising a case having provisions to wholly or substantially accommodate said multi-function card or any conventional transaction card of whatever type, a display; a miniaturised finger pad to select commands in said display, a keyboard to input data to said display, control buttons, one or more microprocessors with suitable memory and processing capacity, a contact module of the type normally used in conventional transaction cards positioned to make contact with a complementary contact module of a card positioned in said case for the purpose of transmitting data to and from said card and for conducting electrical current from said functionality transfer unit, one or more aerials to transmit data and radio-frequency energy to said multi-function card and to conventional transaction cards and to receive data from said cards, a suitable battery and charger, a power supply unit supplied with electrical current from a mains supply; and an external, detachable magnetic stripe module for reading data from said multi-function card and from conventional transaction cards and for writing data to said multi-function card; all said components being connected as required by suitable data-carrying or electrical current supplying circuitry; said functionality transaction unit reading data from a conventional transaction card contactlessly via said aerials, in contact mode via said contact modules or from a magnetic stripe via said external magnetic stripe reader, command inputs for said data reading and subsequent analysis of the read data being delivered by an operator to said functionality transfer unit via a stylus applied to said finger pad to scroll though and select an appropriate command in said display, said command being executed by pressing the appropriate control button; requests for a PIN number or other security code appearing as a command in said display being complied with via said keyboard; analysis of cryptographically-protected cards and extraction of normally inaccessible data being performed via attacks of well known types, said attack procedures being stored in memory in said functionality transfer unit and operated automatically following said command inputs; extracted data being held in memory in said functionality transfer unit and transferred, as required, to said multi-function card by placing said card in said functionality transfer unit, selecting the appropriate command in said display and executing the command by pressing the appropriate control button.

2. The system of claim 1 in which said functionality transfer unit and said multi-function card are able to analyse and extract data from all conventional transaction cards and to store said data in said multi-function card for the making of transactions and the performance of other, non-transaction functions.

3. The system of claim 1 in which said extracted data is stored in said functionality transfer unit in a plurality of discrete memories of said microprocessors.

4. The system of claim 1 in which, when data has been correctly written by said functionality transfer unit to said multi-function card, said functionality transfer unit generates an audible tone, illuminates a light-emitting diode or displays a confirmatory message in said display.

5. The system of claim 1 in which said multi-function card is an active card, its battery being charged from said functionality transfer unit by radio-frequency energy passing between said aerials or by direct contact via said contact modules.

6. The system of claim 1 in which said multi-function card and/or conventional transaction cards are passive cards, powered from said functionality transfer unit by radio-frequency energy passing between said aerials.

7. The system of claim 1 in which said functionality transfer unit body part is covered by a hinged, clam-shell-type cover pivotally attached to one end of said body part, circumferential flanges provided around the edges of said cover and said body part being made such that one passes inside the other in a light interference fit, thereby preventing the ingress of dust.

8. The system of claim 1 in which said control buttons are ‘On’ and ‘Off’ buttons for powering up and powering down said functionality transfer unit, with a third ‘Execute’ button for the initiation of commands.

9. The system of claims 1 and 7 in which said aerials of said functionality transfer unit are positioned beneath radio-transparent material adjacent the upper surface of said case or the upper surface of said cover.

10. The system of claim 1 in which said body part of said functionality transfer unit is provided with a suitably shaped recess to wholly or substantially accommodate said multi-function card or any conventional transaction card of whatever type.

11. The system of claims 1 and 10 in which said functionality transfer unit body part incorporates a bridge beneath which said multi-function card or a conventional transaction card is inserted to be read from or written to in contact mode, a contact module incorporated into the underside of said bridge contacting a complementary contact module of said cards.

12. The system of claims 1 and 10 in which said functionality transfer unit body part incorporates a suitably shaped recess into which said multi-function card or a conventional transaction card is inserted to be read from or written to in contact mode, a contact module incorporated into the upper surface of said recess contacting a complementary contact module of said cards.

13. The system of claim 1 in which said multi-function card or a conventional transaction card is placed upon said body part or said cover of said functionality transfer unit to be read from or written to contactlessly via said aerials.

14. The system of claims 1 and 8 in which said control buttons are contained in a separate module incorporated into said functionality transfer unit.

15. The system of claim 1 in which said functionality transfer unit body part is able to completely enclose said multi-function card and is suitably screened to prevent surreptitious contactless reading of said card.

16. The system of claim 1 in which said aerials are configured or configurable to work at the two common card frequencies of 125 kHz and 13.56 MHz.

17. The system of claim 1 in which said aerials are configured or configurable to work in the Gen 2 UHF frequency range 860-960 MHz.

18. The system of claim 1 in which said microprocessors take the form of a single chip controlling the communication interfaces or separate chips attached to each interface (hybrid card).

19. The system of claim 1 in which said microprocessors are based upon a multi-core chip with suitable memory management.

20. The system of claim 1 in which said electrical current collection means comprise a capacitor and rectification means, a said aerial and capacitor forming a tuned circuit when said aerial is exposed to a suitable radio-frequency field, electrical power being received by resonant energy transfer.

21. The system of claims 1 and 20 in which electrical current flowing to said capacitor is rectified and supplied to said battery charging means and thence to said battery, said battery charging means monitoring the charge state of said battery and, when it is fully charged, interrupting the flow of charging current.

22. The system of claim 1 in which said multi-function card incorporates a fingerprint sensor or generates a one-time password, displayed in said display of said functionality transfer unit, for use in the making of on-line banking applications.

23. The system of claim 1 in which said multi-function card magnetic stripe is rewritable and acts only as a passive data recording medium, to which data is written and from which data is subsequently read.

24. The system of claim 1 in which said microprocessors of said functionality transfer unit draw electrical current directly from said power supply, rather than from said battery.

25. The system of claims 1 and 21 in which, when the charging of said multi-function card is complete, said functionality transfer unit display shows the legend, ‘Card Charged’, or a light-emitting diode on said functionality transfer unit is illuminated or an audible tone is sounded by said functionality transfer unit.

26. The system of claim 1 in which, where said process of analysis of a conventional transaction card is complex, said process is managed by a dedicated microprocessor in said functionality transfer unit, said microprocessor containing all necessary memory capacity and management and analysis software.

27. The system of claims 1 and 26 in which a said microprocessor is loaded with an EMV card browser, which allows reading of the contents of the chip on a conventional transaction card that is a Chip and PIN/EMV smart card.

28. The system of claims 1, 2 and 26 in which, in extracting the normally inaccessible data of a conventional transaction card, said functionality transfer unit imitates a merchant point-of-sale card reader unit and processes a number of zero-value, dummy transactions, knowledge of the input data, the challenges generated by said imitation point-of-sale card reader, the PIN, and the responses generated by the card in said series of dummy transactions offering the possibility of predicting the unique, unpredictable, 32-bit single-use number generated for each transaction.

29. The system of claims 1 and 28 in which data derived from the said replication process is carried in memory in said functionality transfer unit and, as required, is written to said multi-function card by selection by the operator of the appropriate command in said functionality transfer unit display and execution of said command by pressing of said ‘Execute’ button.

30. The system of claim 29 in which, where said dummy transactions are employed to copy an EMV transaction card, in said multi-function card the transaction counter normally incremented with each payment or chip authentication transaction is reset to the position existing in said conventional transaction card at the time of its replication.

31. The system of claim 30 in which, because of the discrepancy in said transaction counter readings between the two said cards, said conventional transaction card cannot be used to make EMV transactions made while said multi-function card is in use.

32. The system of claims 1 and 26 in which said multi-function card is enabled to perform EMV magnetic stripe transactions at any EMV contactless payment terminal, analysis of a conventional EMV transaction card being conducted as an automated process by a dedicated microprocessor in said functionality transfer unit, the attack relying not on issues in terminal implementations, but using a design flaw in which the possible range of the secret numbers generated by said card is greatly reduced; the Unpredictable Number field used in COMPUTE CRYPTOGRAPHIC CHECKSUM, normally a 4-byte value, being reduced by the EMV Kernel 2 specification limitation of the contents of this field to a BCD (binary coded decimal)-encoded numeric value; the field being further reduced by the magnetic stripe protocol such that the unpredictable number may have, at most, 3 digits and is therefore in the range from 0 to 999; dynamic CVC3s being generated by selecting the credit/debit card application and a sequence of GET PROCESSING OPTIONS followed by COMPUTE CRYPTOGRAPHIC CHECKSUM being repeated for every CVC3; approximately one minute of communication with an EMV magnetic-stripe card being sufficient to pre-generate sufficient information for performing successful payment transactions; non re-use of ATC+CVC3 sets generated during the attack by said EMV transaction card permitting said multi-function card to continue to be used in magnetic stripe mode; data derived from said replication process being carried in memory in said functionality transfer unit and, as required, written to said multi-function card.

33. The system of claims 1 and 26 in which, in regions supporting the full Pay-Pass microchip protocol (EMV mode and magnetic stripe mode), the card and the terminal support EMV-mode and will perform an EMV-mode transaction without falling back to magnetic stripe mode such that a clone card that contains a copy of all static card data and the pre-played list of UN+ATC+CVC3 sets will cause a terminal to perform an EMV-mode transaction which is not supported by that simple clone card; while normally working only for terminals supporting Kernel 2's magnetic stripe mode, terminals can be tricked into using the magnetic stripe protocol, even though the original card supports EMV-mode, said tricking being achieved by changing the application interchange profile contained in the response to the GET PROCESSING OPTIONS command; while the original application interchange profile containing a flag indicating support for EMV-mode, the modified application interchange profile has this flag cleared simply by setting the new application interchange profile to 0000, the procedure being effective because magnetic stripe-mode does not provide any means to authenticate the data returned in response to the GET PROCESSING OPTIONS, thus making it possible to create a functional contactless magnetic stripe card with pre-played data extracted from a genuine card supporting EMV-mode; said clone card functionality being restricted to that of a Kernel-2-compatible, contactless EMV card presented at any payment terminal accepting Kernel-2 cards; data derived from the replication process being carried in memory in said functionality transfer unit and, as required, written to said multi-function card; the said attack being conducted as an automated process by a dedicated microprocessor in said functionality transfer unit.

34. The system of claims 1 and 26 in which the Java Card application is employed in the creation of clone cards, said application running on an NXP JCOP card and providing a rudimentary, contactless, EMV/magnetic stripe interface and a second interface (“clone card interface”) to copy pre-play data onto the card, the EMV magnetic stripe interface responding with static data structures extracted from the transaction analysis in Appendix A for the commands SELECT PPSE, SELECT credit/debit application, and GET PROCESSING OPTIONS; by using the application interchange profile of a magnetic stripe card in response to the GET PROCESSING OPTIONS command, the clone card automatically performing the attack and not advertising EMV mode capabilities, in response to the READ RECORDS command for the magnetic stripe data (record 1 of the elementary file with the short file ID 1), the clone card responding with a byte array that can be customized through the clone card interface, the clone card interface providing a command SET MAGSTRIPE DATA for this purpose; in response to COMPUTE CRYPTOGRAPHIC CHECKSUM, said clone card looking up the random number received from the POS terminal in a list of available UN+ATC+CVC3 sets and returning the ATC and the CVC3 codes, the card returning the error code 6F00f if no UN+ATC+CVC3 set is available for the given unpredictable number, the list of UN+ATC+CVC3 sets being able to be loaded into the card through the clone card interface's command SET MAGSTRIPE AUTH, after collecting the pre-play data from a conventional transaction card, the Android application expecting the user to tap a second card with the clone card interface; the Android application first storing the collected magnetic stripe data onto the clone card with the SET MAGSTRIPE DATA command, following which, the application storing all collected UN+ATC+CVC3 sets onto the clone card using the SET MAGSTRIPE AUTH command; in this method, said functionality transfer unit taking the place of said second card, data derived from the replication process being carried in memory in said functionality transfer unit and, as required, written to said multi-function card; the said attack being conducted as an automated process by a dedicated microprocessor in said functionality transfer unit.

35. The system of claims 1 and 26 in which, where the type of conventional transaction card selected in said functionality transfer unit display is, for example, a card based upon a cryptographically-protected, contactless memory chip, for example, the Mifare DESFire MF31CD40, a so-called side channel attack is made, special equipment being employed in said attack to contactlessly record power signals from the chip and to analyse them to extract the chip cryptographic keys, said attack being performed as an automated process managed by a dedicated microprocessor in said functionality transfer unit; said attack being conducted in contactless mode by feeding data to said chip (stimulation), using an electromagnetic probe (not shown) to record the power signal taken by said chip, and analysing the recorded signals; said microprocessor containing said stimulation data, a memory for storing said recorded data and software to manage said attack and to analyse said recorded data; said electromagnetic probe forming part of said functionality transfer unit.

36. The system of claim 35 in which a low-bandwidth attack is performed, as appropriate, by measuring the electrical potential of a computer chassis or by measuring leakage from the ground wires at the remote end of VGA, USB or Ethernet cables.

37. The system of claims 1, 26 and 36 in which a so-called side channel attack to replicate a conventional transaction card that is an EMV card conducts an acoustic cryptanalysis key extraction attack through stimulation by decryption of selected cybertexts and recording the resultant acoustic emanations typically caused by voltage regulation circuits; cryptographic keys being clearly distinguished by the sound made when they are used, said selected ciphertexts causing numerical cancellations such that the special value zero appears frequently in the innermost loop of the algorithm where it affects control flow, the effect being repeated and amplified over many thousands of iterations, resulting in a gross leakage effect that is discernible in the acoustic spectrum over hundreds of milliseconds and allowing extraction of whole 4096-bit RSA keys; the process of stimulation, acoustic recording and analysis being managed by a dedicated microprocessor having suitable memory capacity and management and analysis software, a microphone used to record the acoustic signals forming part of said functionality transfer unit; the extracted data being carried in memory in said functionality transfer unit and, as required, written to said multi-function card.

38. The system of claims 1, 35, 36 and 37 in which said electromagnetic and acoustic side channel attacks and their associated processes of stimulation, recording, analysis and cryptographic key extraction are performed in a separate module, plug-connectable to said functionality transfer unit.

39. The system of claims 1, 35, 36 and 37 in which said electromagnetic and acoustic side channel attacks and their associated processes of stimulation, recording, analysis and cryptographic key extraction are performed in a separate computer, the data so generated being transferred by cable to said functionality transfer unit.

40. The system of claim 1 in which, in order to change one normal transaction card functionality loaded into said multi-function card for another, said multi-function card is inserted into said functionality transfer unit, a command to make the change is selected in said functionality transfer unit display and executed, the desired card functionality is selected in said display and executed, the operator optionally using said keyboard to identify the desired card functionality, execution being accomplished by pressing said ‘Execute’ button.

41. The system of claim 1 in which provision is made for different conventional transaction card functionalities to be installed in said multi-function card and for each to become active at different times of a day or on different days of the week.

42. The system of claims 1 and 8 in which provision is made to transfer funds from or to said multi-function card to or from a stored value conventional transaction card (debit card), or from one stored value conventional transaction card to another, said transfer being performed by placing the first card in said functionality transfer unit, selecting an appropriate command in said display and inputting the amount to be deducted via said keyboard, then placing a second card in said functionality transfer unit and selecting a command to credit the previously-deducted funds to said second card, all said commands being executed by pressing said ‘Execute’ button.

43. The system of claim 1 in which said multi-function card is linked to said functionality transfer unit by a suitable password or security code and said multi-function card and said functionality transfer unit can only be used as a pair.

44. The system of claim 1 in which a separate, external module is provided incorporating contact or contactless read/write functions and magnetic stripe read/write functions is attached to a smart phone, said smart phone providing all said functions of said functionality transfer unit.

45. The system of claim 1 in which a separate, external module is provided incorporating contact or contactless, read/write functions and magnetic stripe read/write functions is attached to a smart phone, said smart phone providing all said functions of said functionality unit and said multi-function card.

46. The system of claims 1, 44 and 45, in which, where said smart phone provides said functionality of said functionality transfer unit, QR codes are employed to validate the connection of said smart phone to said functionality transfer unit for the purpose of transferring data between said functionality transfer unit and said smart phone.

47. The system of claims 1, 44 and 45, in which, where said smart phone provides said functionality of said multi-function card, instead of inputting said password or security code to activate said multi-function card functions, said smart phone scans a QR code printed on said cover or upper surface of said functionality transfer unit.

48. The system of claim 1 in which said multi-function card is deactivated as required by said functionality transfer unit and can only be reactivated by using said password or security code.

49. The system of claim 1 in which said keyboard is made to pivot out from said body part of said functionality transfer unit to facilitate access to said keyboard.

50. The system of claim 1 in which said multi-function card and said functionality transfer unit are powered by photovoltaic panels.

51. The system of claim 1 in which said process of analysis and cryptographic key extraction of EMV cards and the loading of said extracted data into said multi-function card is performed by a separate, trusted agency.

52. The system of claim 1 in which said functionality transfer unit automatically de-powers itself after a pre-set period of inactivity, said password or security code being required to re-power it.

53. The system of claim 1 in which said multi-function card is able to be employed for storage of medical records; or employed for storage of biometric data, including facial images, fingerprints, iris images, the geometry of a hand, finger, or thumb, or of some pattern of the person's behavior, such as the dynamics of signature-writing or password-typing; biometric data is able to be employed to test whether the person presenting the card is likely to be the same as the person to whom it was issued, or employed to positively identify persons by law enforcement or security personnel, or employed as a means of unlocking the encryption keys stored on a device chip; identification smart cards also being able to be used to store historical data relating to attendance by card holders at places where cards are employed for access purposes.
